(19) United States
(12) Patent Application Publication
(10) Pub. No.: US 2010/0225592 A1
(43) Pub. Date: Sep. 9, 2010

(54) APPARATUS AND METHOD FOR INPUTTING CHARACTERS/NUMERALS FOR COMMUNICATION TERMINAL

(76) Inventor: Won-Hyong Jo, Seoul (JP)

Correspondence Address: COLEMAN SUDOL SAPONE, P.C., 714 COLORADO AVENUE, BRIDGE PORT, CT, 06605-1601, US

(21) Appl. No.: 12/733,978

(22) PCT Filed: Oct. 6, 2008
(86) PCT No.: PCT/KR2008/005847

§ 371 Date: Mar. 31, 2010

(30) Foreign Application Priority Data
Oct. 8, 2007 (KR) 10-2007-0100689

(51) Int. Cl. G06F 3/02

(52) U.S. Cl. 345/171

(57) ABSTRACT

An apparatus and method for inputting characters/numerals for a communication terminal provided with a touch part is disclosed. A plurality of block groups including 9 touch regions are formed on a panel of the touch part, through which designation of coordinates or selection of characters can be performed using a finger or a tool, for communications with an outside or data storage, and characters for each language and numerals/symbols can be conveniently inputted through at least one active block generated by a touch signal in each block.

### TECHNICAL FIELD

The present invention relates to an apparatus and method for inputting characters/numerals. More particularly, the present invention relates to an apparatus and method for inputting characters/numerals for a communication terminal, in which consonants and vowels are arranged on various kinds of block regions on a touch screen in the order of the principles of human pronunciation, and an input of characters/numerals can be simply and conveniently performed using not only a tool but also a finger.

### BACKGROUND ART

Human centric interface (HCI) means a human-oriented interface, and includes all technologies belonging to a human interface that makes a human-machine interface natural as a human-human interface. Recently, information terminals are diversified into not only cellular phones, notebook computers, PCs but also MP3 players, PDA, and the like, and one appliance provides bidirectional functions of the cellular phone, PDA, MP3 player, camera, and the like. The importance of the user-oriented interface becomes greater.

In the year 2000, starting a new thousand years, human interface technology has been once selected as one of 10 important technologies for future 10 years.

The human interface technology is not independently provided, but is included in diverse products. Since the HCI field is a user interface field, it is required to easily and quickly provide an interface desired by users. The human interface may be a field that reflects the client's inclination rather than the technology itself.

Currently, technology of an input device in a portable terminal has been developed with some features. With the trend of slim cellular phones, cellular phone manufacturers prefer TACT switches as contacts in keypads since consumers are long familiar with keypads.

In the case of a smart phone that is gradually spread in the market, a QWERTY keyboard is employed as an input device of the smart phone.

At present, the QWERTY keyboard is the fastest input device among the currently developed input devices, and the manufacturers prefer to select this type of input device.

However, keys provided on the smart phone are relatively small, and this disturbs the key input speed. Accordingly, with the current tendencies in complexity with PMP, navigation, DMB, and the like, some smart phones adopt keyboards installed in touch screens by software.

Touch screen technology has been developed around PDA terminals, and includes an input system sensing a resistance value of a finger and an input system sensing a capacitance value between contact surfaces. Recently developed touch screen character input apparatuses and methods somewhat make up for the existing problems, but require complicated manipulation with a finger or a tool and accuracy to cause users to have severe fatigue. These apparatuses and methods also have the problem that the size of buttons is too small for the users to input them with their fingers.

Accordingly, it is not considered that the recently developed touch screen character input apparatuses and methods greatly improve the existing inconvenience, and thus terminal manufacturers cannot easily determine their production. Nevertheless, application of such touch screen input devices to high-class cellular phones and some smart phones has been gradually spread.

Since it is very important to overcome the limits of displays and input systems for their functions as multimedia devices truly desired by users, the roles of useful touch screen character input methods and apparatuses have become much greater.

### DISCLOSURE TECHNICAL PROBLEM

Accordingly, the present invention has been made to solve the above-mentioned problems occurring in the prior art while advantages achieved by the prior art are maintained intact.

An object of the present invention is to provide an apparatus and method for inputting characters/numerals for a communication terminal, in which a plurality of block groups including 9 touch manipulation regions are formed on a panel of a touch part, at least one active block that is generated by touch signals on the respective blocks is constructed, and thus an input of characters/numerals by languages using a communication terminal can be conveniently performed.

Another object of the present invention is an apparatus and method for inputting characters/numerals for a communication terminal, which can make it possible to input three phonemes at maximum through a user's once manipulation and thus can remarkably increase an input speed of characters/numerals by arranging consonants and vowels on various kinds of block regions formed on a touch screen in the order of the principles of human pronunciation, and also can make it possible to input characters using not only a tool but also a finger by expanding only a manipulation region that is used to input the characters.

### TECHNICAL SOLUTION

In order to achieve the above and other objects, there is provided an apparatus for inputting characters/numerals for a communication terminal provided with a touch part, through which designation of coordinates or selection of characters can be performed using a finger or a tool for communications with an outside or data storage, according to the present invention, which includes a touch key block selection means including a plurality of selection blocks in the touch part and providing a corresponding touch key block indicated on a corresponding block as visual images in accordance with a user's touch manipulation; the touch key block provided as a display by the touch key block selection means and including a center manipulation region defined by a first closed curve and allocated with consonants, vowels, numerals, symbols, and function keys by languages including Hangeul, Roman characters, and Japanese, and a first manipulation region surrounded by a second closed curve, formed with 8 closed sectors composed of upper, lower, left, right, upper left, upper right, lower left, and lower right sectors each having a cut fan shape, and allocated with consonants, vowels, numerals, symbols, and function keys by languages including Hangeul, Roman characters, and Japanese, the first manipulation region being displayed and activated when a touch signal is generated, and being automatically inactivated if a specified time elapses after the touch signal disappears; a second manipulation region provided on an outer side of the touch key block, which neighbors at least one fan-shaped closed sector, and allocated with consonants, vowels, numerals, symbols, and function keys by languages, the second manipulation region being displayed and activated when the touch signal of the first manipulation region is generated, and being automatically inactivated if a specified time elapses after the touch signal disappears; a character storage unit storing character data by languages used in the character input apparatus; a program memory storing an inner operating program of the communication terminal; a code storage unit storing code data corresponding to the touch signal of the communication terminal; a touch key block recognition unit detecting a manipulation state of the finger or the tool in the respective touch key blocks provided on the communication terminal; a second manipulation region recognition unit detecting the manipulation state of the finger or the tool in the second manipulation region provided on the communication terminal; a microprocessor judging of which language a user inputs a phoneme with reference to the character data stored in the character storage unit in accordance with the operating program stored in the program memory when a finger or tool manipulation state detection signal is inputted through the touch key block recognition unit or the second manipulation region recognition unit, and generating and outputting a display control signal for displaying phonemes of the corresponding language inputted by the user with reference to the code data stored in the code storage unit; a display drive unit outputting a drive control signal for displaying the visual images of the touch key block selection means or the touch key block and the second manipulation region selected by the user through manipulation of the finger or the tool in the touch region and characters and numerals/symbols generated in accordance with the touch signal of the corresponding manipulation region, in accordance with the display control signal outputted from the microprocessor; and a display unit displaying the touch key block selection means, the touch key block, the second manipulation region, the characters, and the numerals/symbols on a display screen as the visual images in accordance with the drive control signal outputted from the display drive unit.

In another aspect of the present invention, there is provided a method for inputting characters/numerals for a communication terminal, which includes (1) a microprocessor of the communication terminal judging whether a user selects a character mode for each language; (2) the microprocessor of the communication terminal judging which mode among a Hangeul input mode, a Roman character input mode, and a Japanese input mode the user who has selected the character mode selects; (3) if the Hangeul input mode is selected, the microprocessor of the communication terminal detecting a touch signal inputted from a touch key block and a second manipulation region, combining consonants, vowels, and numerals/symbols of a corresponding Hangeul character, and displaying the combined Hangeul character on a display screen of the communication terminal; (4) if the Roman character input mode is selected, the microprocessor of the communication terminal detecting a touch signal inputted from the touch key block and the second manipulation region, combining consonants, vowels, and numerals/symbols of a corresponding Roman character, and displaying the corresponding Roman character on the display screen of the communication terminal; (5) if the Japanese input mode is selected, the microprocessor of the communication terminal detecting a touch signal inputted from the touch key block and the second manipulation region, combining consonants, vowels, and numerals/symbols of a corresponding Japanese character, and displaying the corresponding Japanese character on the display screen of the communication terminal; (6) if a character input work through any one input mode selected among the Hangeul input mode, the Roman character input mode, and the Japanese input mode is finished, the microprocessor of the communication terminal judging whether the user selects a character storage and storing the character inputted by the user; and (7) the microprocessor of the communication terminal judging whether the user ends the character mode, and continuing or removing the character mode.

### ADVANTAGEOUS EFFECTS

As described above, according to the apparatus and method for inputting characters/numerals for a communication terminal according to the present invention, a plurality of block groups including 9 touch manipulation regions are formed on a panel of a touch part for designating coordinates or selecting characters using a finger or a tool for communications with an outside or data storage. Accordingly, an input of characters and numerals/symbols for each language can be conveniently made with a plurality of active blocks that are generated by touch signals on the respective blocks, and a user can promptly and conveniently input various kinds of characters/numerals of Hangeul, Roman characters, and Japanese with a smaller number of inputs or manipulations than the communication terminal provided with the existing touch screen type keyboard, so that the apparatus and method according to the present invention can contribute to the substantial spread of communication terminals adopting touch screen key input devices. Also, since the apparatus and method according to the present invention makes it possible to input characters/numerals more promptly and conveniently, it is effective in implementing document works, e-mail, chatting, Internet information search, and the like.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a view explaining the structure and manipulation of an existing touch screen keyboard;

FIG. 2 is a view schematically illustrating the structure of a communication terminal according to an embodiment of the present invention;

FIGS. 3A to 3C are views illustrating examples of touch key blocks of a communication terminal according to an embodiment of the present invention;

FIG. 4 is a view explaining a touch key block selection means;

FIG. 5 is a block diagram schematically illustrating the inner construction of an apparatus for inputting characters/numerals for a communication terminal according to an embodiment of the present invention;

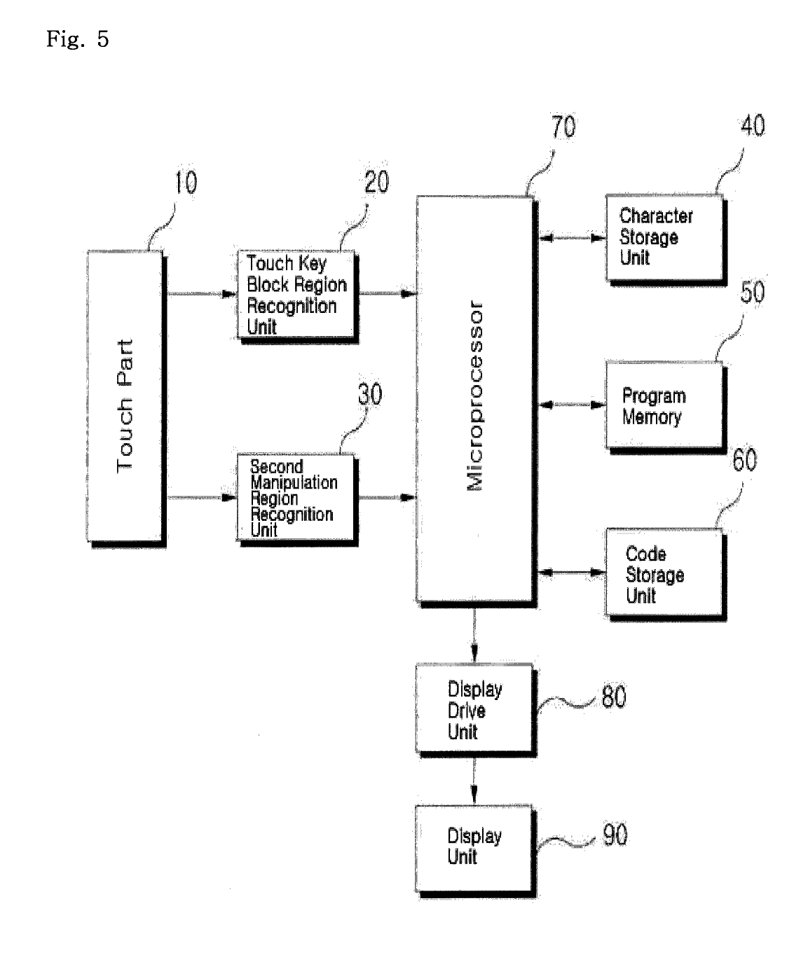

FIG. 6 is a view illustrating examples of Hangeul touch key blocks of an apparatus for inputting characters/numerals for a communication terminal according to an embodiment of the present invention;

FIG. 7 is a view illustrating examples of Roman character touch key blocks of an apparatus for inputting characters/numerals for a communication terminal according to an embodiment of the present invention;

FIG. 8 is a view illustrating examples of Japanese touch key blocks of an apparatus for inputting characters/numerals for a communication terminal according to an embodiment of the present invention;

FIGS. 9A and 9B are views illustrating examples of touch manipulation in an apparatus for inputting characters/numerals for a communication terminal according to an embodiment of the present invention;

FIG. 10 is a flowchart illustrating a method for inputting characters/numerals for a communication terminal according to an embodiment of the present invention;

FIG. 11 is a flowchart illustrating detailed processes of a Hangeul input mode routine in FIG. 10;

FIG. 12 is a flowchart illustrating detailed processes of a Roman character input mode routine in FIG. 10; and

FIG. 13 is a flowchart illustrating detailed processes of a Japanese input mode routine in FIG. 10.

### BEST MODE

Hereinafter, an apparatus and method for inputting characters/numerals for a communication terminal according to the preferred embodiments of the present invention will be described in detail with reference to the accompanying drawings. As illustrated in the drawings, a touch key block T of a touch part 10 is composed of a touch panel for selecting characters using a finger or a tool for communications with an outside or data storage.

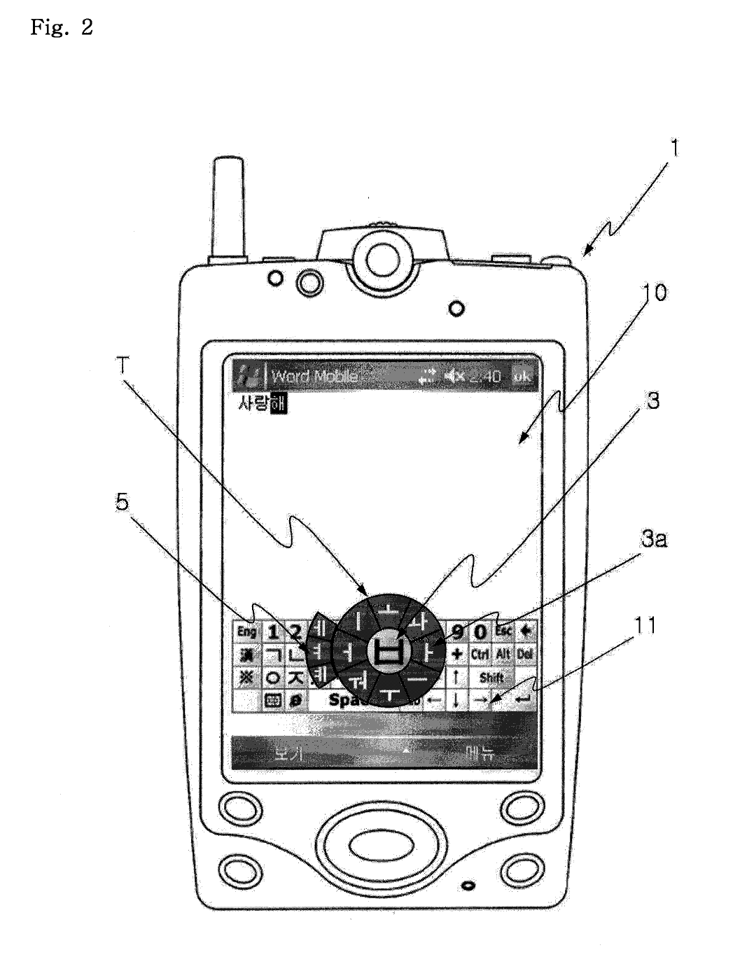

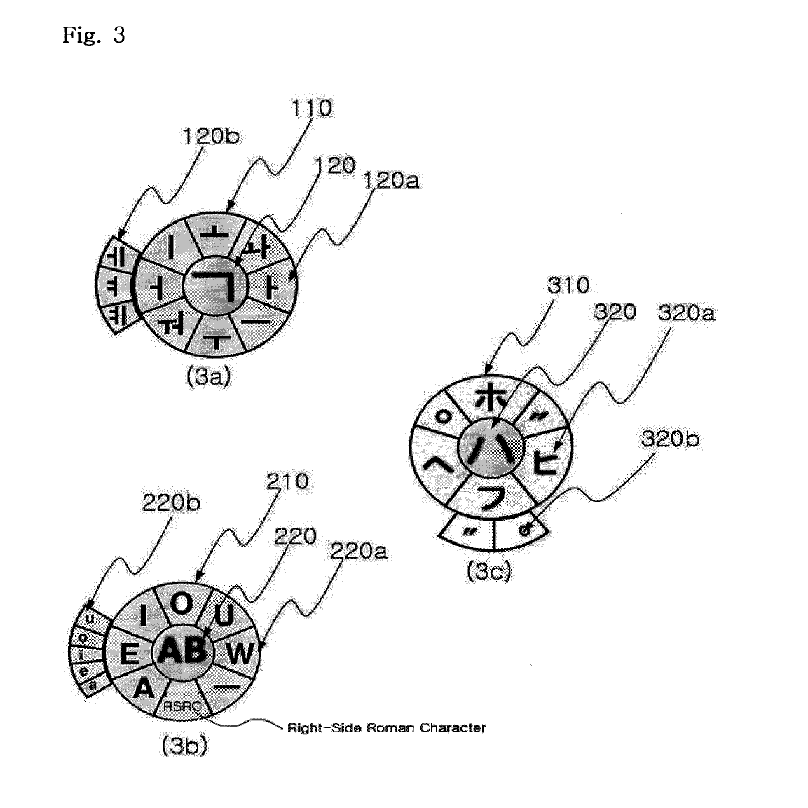

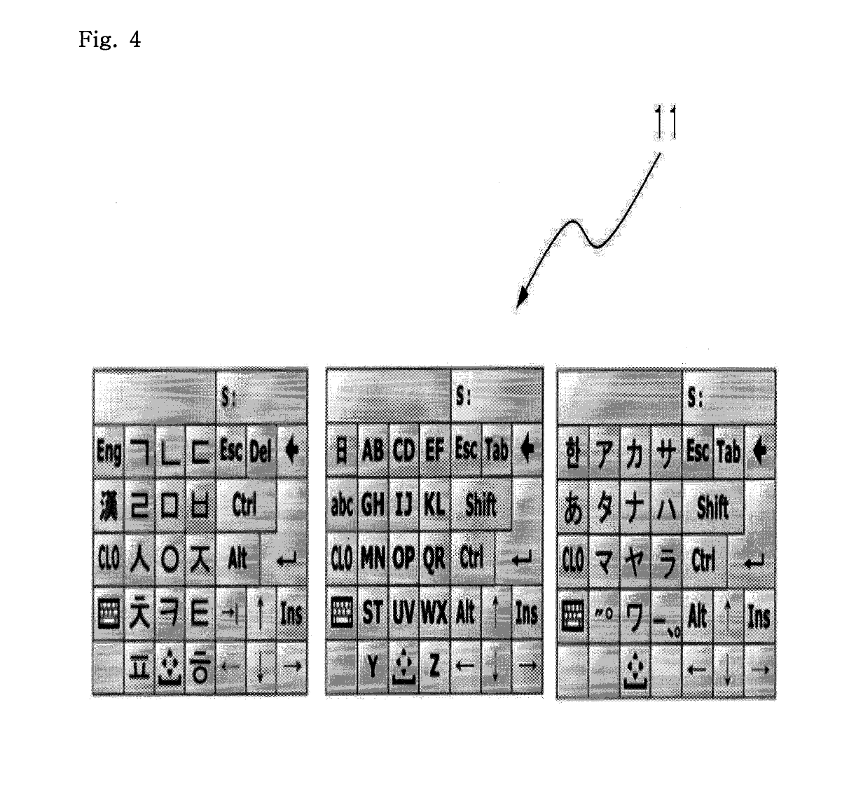

The touch key block T includes a center manipulation region 3 defined by a first closed curve and allocated with Hangeul (i.e. Korean language) consonants, two Roman characters, [symbol] dan [symbol] of each gyo [symbol] of Japanese, numerals, symbols, and function keys, and a first manipulation region 3a surrounded by a second closed curve, formed with 8 closed sectors composed of upper, lower, left, right, upper left, upper right, lower left, and lower right sectors each having a cut fan shape (See FIGS. 3A to 3C), and allocated with Hangeul single-vowels, Roman vowels, [symbol] dan, [symbol] dan, [symbol] dan, and [symbol] dan of each gyo of Japanese, other special characters, and function keys (See FIGS. 2, 3A to 3C, 6, 7, and 8). As described above, the touch key block T includes 9 closed sectors in all, and can be displayed only through a touch key block selection means 11 (See FIGS. 2 and 4).

The touch key block selection means 11 appears similar to a general touch screen keyboard, but has no keyboard function (See FIG. 4). The touch key block selection means 11 indicates consonants and vowels of each language, numerals, symbols, and function keys, but actually operates only as means for calling the touch key block T (See FIG. 2).

The touch key block T is not ordinarily shown to be in a standby state, and if a user touches an image (See FIG. 4) indicated on the touch key block selection means 11, the touch key block T that corresponds to the image is activated to be visually displayed (See FIG. 2).

Also, just after the user's finger or the tool becomes in contact with the touch key block T, the touch key block T disappears from the touch part 10. Even if the keyboard is not seen on the touch screen, the user can recognize its position through the touch key block selection means 11.

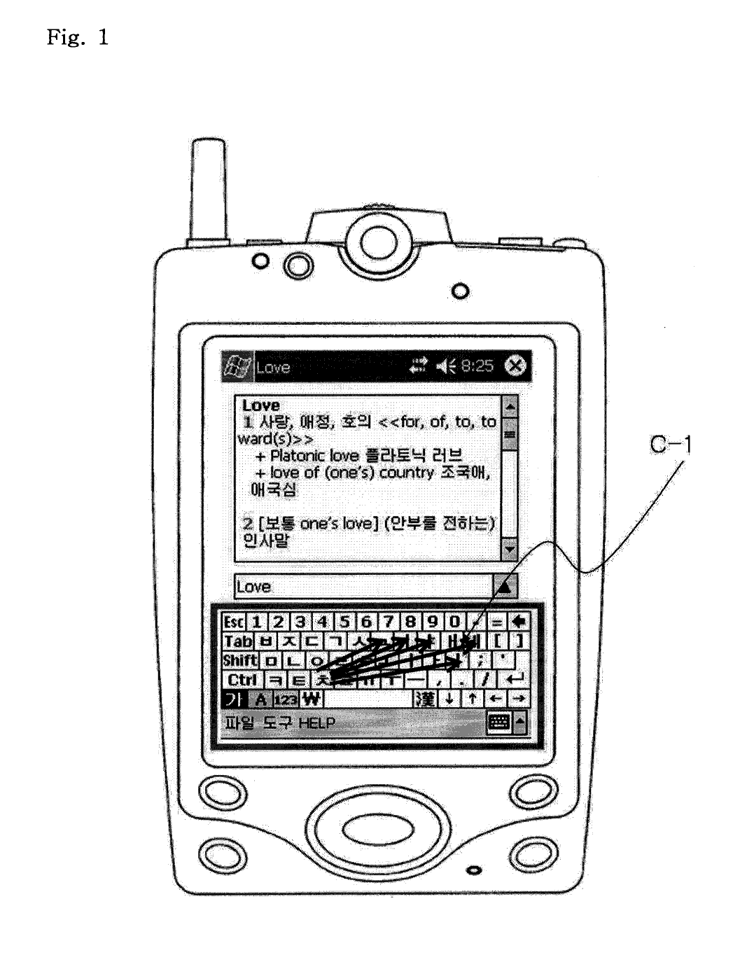

In the case of the existing touch screen keyboard (See FIG. 1), the keyboard itself is so small that it is difficult for a user to input characters using his/her finger. Also, it takes a long time for a user to input characters through small-sized key buttons.

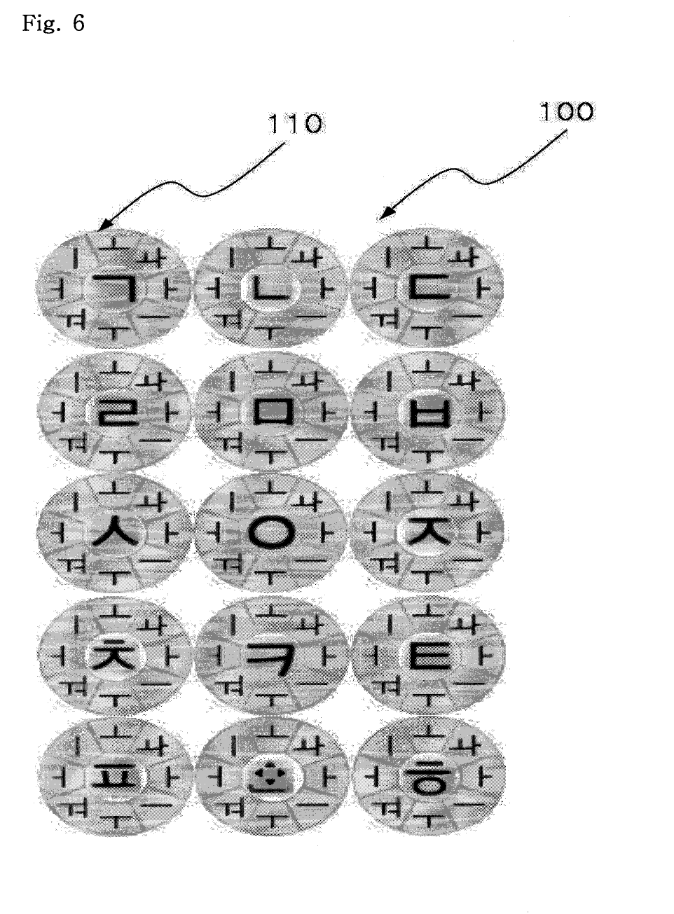

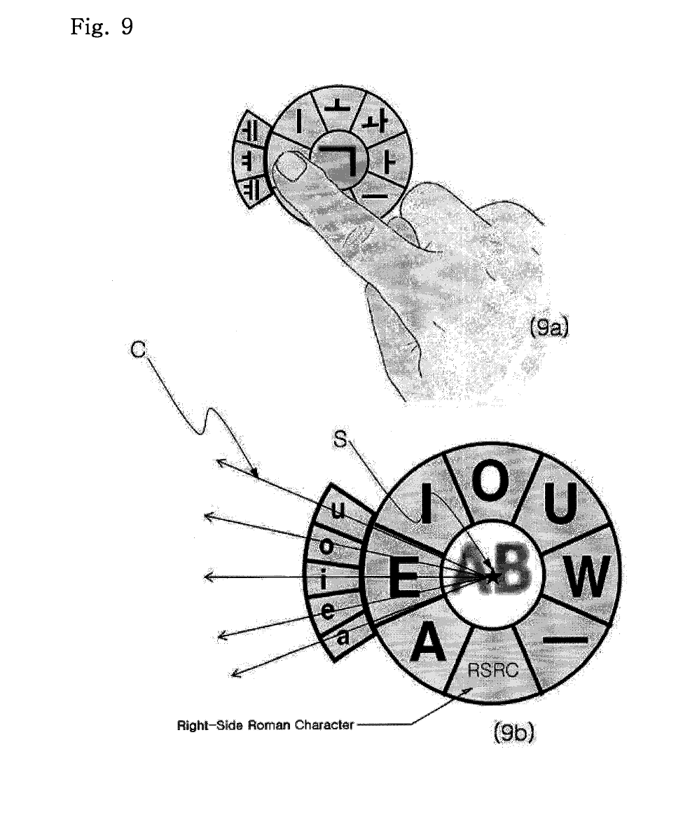

The touch key block T according to the present invention is large-sized, and thus the user can input characters by touching the key buttons with his/her finger (See FIGS. 9A and 9B). Also, since only buttons required for the character input are activated, the touching of the key buttons is not restricted by a small screen. If all the touch key blocks T are displayed on the touch part 10, it becomes impossible for the user to input characters using his/her finger (See FIGS. 6 to 8).

According to another feature of the touch key block T, the touch key block is displayed around the center S of the touched point. Since the user cannot touch the same coordinates whenever he/she touches a specified image of the touch key block selection means 11, the display position of the touch key block T is varied in accordance with the point which the finger of the user or the tool becomes in contact with. When the touch key block T is displayed to match the user's finger or the tool, the user will always be in an optimal position S for inputting the characters.

In inputting the character using the user's finger or the tool, the reason why it is important to keep the user's optimal position S is as follows.

In the center of the touch key block T, the center manipulation region 3 is formed by the first closed curve, and is allocated with Hangeul consonants, consonant/vowel of Roman characters, and [symbol] dan of each gyo of Japanese. In the first manipulation region 3a surrounded by a second closed curve, 8 closed sectors are provided, and is allocated with Hangeul and Roman vowels, [symbol] dan, [symbol] dan, [symbol] dan, and [symbol] dan of each gyo of Japanese. The center manipulation region 3 and the first manipulation region 3a are provided with reference to the principles of human pronunciation (See FIGS. 6 to 8).

Human pronunciation is made in the order of ‘consonant+vowel’, ‘vowel+consonant’, and ‘consonant+vowel+consonant’ irrespective of countries and nations. That is, a consonant is mostly positioned before and after a vowel, and this feature is applied to the construction of a keyboard.

The user touches the center manipulation region 3 of the touch key block T, and then straightly moves his/her finger toward the first manipulation region 3a positioned on the outer side of the center manipulation region (See FIG. 9B) to combine the consonant and the vowel. If the user further moves his/her finger straightly, the second manipulation region 5 (See FIG. 9A) appears to combine the diphthong.

The efficiency (See FIG. 9B) of the straight movement (C in FIG. 9B) with the same length and direction is much higher than that of the straight movement with different length and direction. In FIG. 1, it can be seen that the distance and direction of the straight movement differ by the number of vowels.

The straight movement with the same length and direction is much simpler and advantageous in comparison to the bent or curve shaped movement with different length and direction.

Also, since a character input environment in the same position S and with the same direction C and the same length is provided due to the radial block structure around the center S of the touch key block T, the user can be practiced in a short period, and thus can input the characters very intuitively in the short period. The radial block structure has a constant distance from the center to the circumferential part in comparison to the rectangular block structure. Accordingly, the touch key block T is in the form of a circle (See FIGS. 6 to 8).

According to the present invention, the user's touch position is grasp and the position of the touch key block T is varied in accordance with the user's touch position rather than the user is well acquainted with the position of the touch key block T. Accordingly, it is not required for the user to make an effort to accurately press a small-sized key in a small area, and the ratio of erroneous key input is lowered since the user can make a straight movement C of his/her finger in the much more accurate position S.

The second manipulation region 5 is provided on an outer side of the touch key block, and includes at least one cut fan-shaped sector by languages (See FIGS. 3A to 3C). If a touch signal is generated in the first manipulation region 3a, the second manipulation region is displayed and activated, while if no touch signal is generated, the second manipulation region 5 is inactivated and disappears after a specified time elapses.

It is preferable that the second manipulation region 5 is formed in the form of a fan in consideration of the character input through the straight movement, starting from the user's center S (See FIGS. 3A to 3C and 9A and 9B).

A character storage unit 40 stores therein characters by languages including Hangeul characters (e.g. complete type characters), Roman characters, and Japanese characters, numerals/symbols, and special characters, and outputs the characters of the corresponding language under the control of the microprocessor 70.

A program memory 50 stores an operating program of the microprocessor 70.

A code storage unit 60 stores code data corresponding to various kinds of touch key blocks T and the second manipulation region 5 arranged on the touch part 10.

A touch key block recognition unit 20 detects the touch state of the respective touch key blocks T provided on the touch part 10, and outputs the detected touch state to the microprocessor 70.

A second manipulation region recognition unit 30 detects the touch state of the second manipulation region 5 provided on the touch part 10, and outputs the detected touch state to the microprocessor 70.

The microprocessor 70 judges of which language a user inputs a phoneme with reference to the character data stored in the character storage unit 40 in accordance with the operating program stored in the program memory 50 when a touch state detection signal is inputted through the touch key block recognition unit 20 and/or the second manipulation region recognition unit 30, and generates and outputs a display control signal for displaying phonemes of the corresponding language inputted by the user with reference to the code data stored in the code storage unit 60.

A display drive unit 80 outputs a drive control signal for displaying characters and numerals selected by the user through a touch manipulation of the touch key block T or the second manipulation region 5 of the touch part 10 to the display unit 90 in accordance with the display control signal outputted from the microprocessor 70.

A display unit 90 is typically composed of an LCD and so on, and displays the characters and numerals on a display screen in accordance with the drive control signal outputted from the display drive unit 80, so that the user can confirm the characters/numerals inputted by the user.

FIG. 6 is a view illustrating examples of Hangeul touch key blocks of an apparatus for inputting characters/numerals for a communication terminal according to an embodiment of the present invention.

As illustrated in FIG. 6, a Hangeul touch key block group 100 includes a plurality (five rows and three columns) of Hangeul touch key blocks 110. All Hangeul consonants are allocated to the center manipulation region 3 or 120 (See FIG. 6), vowels are allocated to the first manipulation region 3a or 120a (here, eight directions of upper left, upper, upper right, left, right, lower left, lower, and lower right), and 8 vowels of [symbol] [symbol] [symbol] [symbol] [symbol] [symbol] [symbol] and [symbol] are allocated to the corresponding first manipulation region (See FIG. 3A).

In this case, the remaining vowels except for the 8 vowels allocated to the first manipulation region 3a or 120a are allocated to the second manipulation region 5 or 120b.

The number of strokes of the consonants allocated to the second manipulation region is larger than that of the consonants allocated to the first manipulation region, and the consonants allocated to the second manipulation region are allocated to one to three cut fan-shaped closed sections. Specifically, the vowels on the second manipulation region correspond to the vowels on the first manipulation region in a manner that [symbol] corresponds to [symbol] [symbol] [symbol] correspond to [symbol] [symbol] corresponds to [symbol] [symbol] [symbol] [symbol] correspond to [symbol] [symbol] [symbol] [symbol] correspond to [symbol] [symbol] corresponds to [symbol] [symbol] [symbol] correspond to [symbol] and [symbol] corresponds to

[symbol]

That is, if the user straightly moves his/her finger to the first manipulation region 120a that is on the lower right side in a state that the user presses [symbol] consonant allocated to the center manipulation region 3 or 120 on the touch key block T, and then touches the first manipulation region 120a, [symbol] in which [symbol] is combined with the basically allocated vowel [symbol] is displayed, and if the user continues to straightly move his/her finger to the second manipulation region 120b in a state that the user touches the first manipulation region 120a, and then touches the second manipulation region 120b, a vowel [symbol] is added thereto and [symbol] is displayed, so that the vowels except for the 8 basic vowels can be made.

In order to display [symbol] the corresponding touch key block 110 is once touched in its original position, and in order to display [symbol] the center manipulation region 120 of the touch key block 110, to which a consonant [symbol] is allocated, is twice touched in its original position, or the touch state is maintained. Also, in order to display [symbol] the center manipulation region 120 of the touch key block 110, to which the consonant [symbol] is allocated, is once touched, and then the center manipulation region 120 of the touch key block 110, to which the consonant [symbol] is allocated, is once touched to complete the character combination of

[symbol]

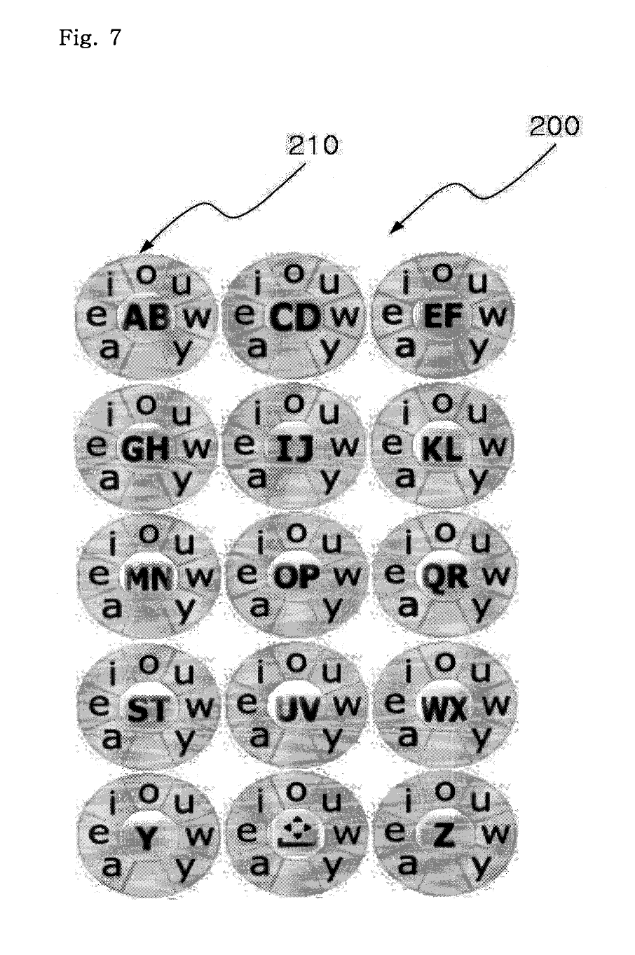

FIG. 7 is a view illustrating examples of Roman character touch key blocks of an apparatus for inputting characters/numerals for a communication terminal according to an embodiment of the present invention.

As illustrated in the drawing, a Roman character touch key block group 200 includes a plurality of (five rows and three columns) of Roman character touch key blocks 210, and two Roman characters are allocated to each center manipulation region 3 or 220 of 13 touch key blocks (See FIG. 7).

Consonants and vowels are allocated (in seven directions of upper left, upper, upper right, left, right, lower left, and lower right) on the first manipulation regions 220a. For example, 7 consonants and vowels of ‘I, O, U, E, W, A, and Y’ are allocated to the corresponding first manipulation region (See FIG. 3B). In this case, the remaining vowels except for the 7 vowels allocated to the first manipulation region 3a or 220a are combined with vowels allocated to the second manipulation region 5 or 220b.

The vowels allocated to the second manipulation region 220b are allocated to 5 cut fan-shaped closed regions, and more specifically, ‘A, E, I, O, and U’ are allocated to correspond to the respective vowels of the first manipulation region 220a (See FIG. 3B).

Also, the lower direction of the first manipulation regions 220a is used to input the second alphabet of two alphabets allocated to the respective center manipulation region 220, i.e., the right-side alphabet (See FIG. 3B). That is, the left-side alphabet of the two alphabets allocated to the respective center manipulation regions 220 on the touch key block T is inputted by once touching the corresponding center manipulation region 220, and the right-side alphabet is inputted by continuously making a straight movement in a state that the user touches the corresponding center manipulation region 220 and touching a ‘right-side alphabet input’ region of the first manipulation region 220a.

In order for a user to input ‘AIE’ in the Roman character touch key block group 200, the user makes a straight movement to the first manipulation region 220a of the upper left side in a state that the user keeps in touch with ‘A’ allocated to the center manipulation region 3 or 220 of the touch key block T to display ‘AI’ obtained by combining ‘A’ with the basically allocated vowel ‘I’, and then the user makes a straight movement to the second manipulation region 220b in a state that the user keeps in touch with the first manipulation region 220a to add ‘E’ to ‘AI’ and display ‘AIE’, so that other vowels except for the 7 basic vowels can be made.

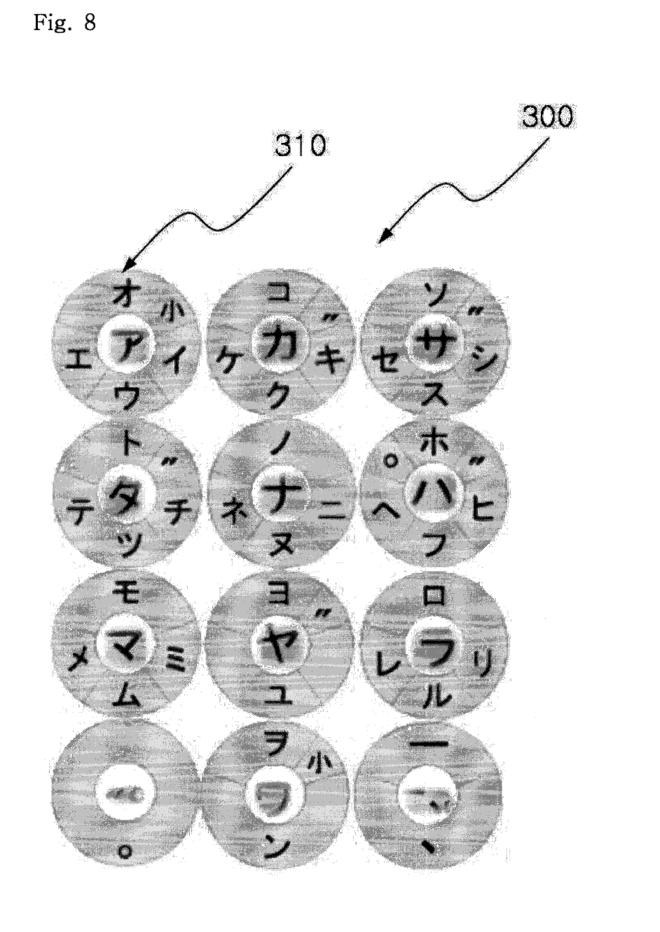

FIG. 8 is a view illustrating examples of Japanese touch key blocks of an apparatus for inputting characters/numerals for a communication terminal according to an embodiment of the present invention.

As illustrated in the drawing, a Japanese touch key block group 300 includes a plurality of (five rows and three columns) of touch key blocks 310, and 10 [symbol] -dan characters of each gyo of Japanese (hiragana or katakana character) are allocated to the center manipulation regions 3 or 320 on 10 buttons.

In the first manipulation region 3a or 320a (e.g. in four directions of upper, lower, left, and right), characters of [symbol] [symbol] [symbol] and [symbol] dan are inputted in four directions of each gyo of Japanese (See FIG. 8).

For example, in order to input [symbol] the user once touches the center manipulation region 320 of the corresponding touch key block 310 positioned in second row and third column. In order to input [symbol] the user continuously makes a straight movement to the left side in a state that the user touches the center manipulation region 320 to which [symbol] of the third row and first column is allocated, and then touches the first manipulation region 320a where the corresponding character exists.

Also, when the character allocated to the respective touch key block 310 is inputted, a pronunciation character [symbol] is inputted by pressing the center manipulation region 320 of the corresponding touch key block 310 once more, and if the center manipulation region 320 of [symbol] allocated to the touch key block 310 is pressed long after the touch key block 310 to which [symbol] dan is allocated is touched, a [symbol] is inputted. If the corresponding region is pressed long after [symbol] allocated to the touch key block 310 is touched, semi-vowels, [symbol] [symbol] [symbol] are inputted. If the corresponding region is once touched long in a state that the character of each dan of [symbol] gyo is inputted, [symbol] of each dan of [symbol] gyo is inputted, and if the corresponding region is once touched long in a state that the character of each dan of [symbol] gyo is inputted, [symbol] [symbol] [symbol] [symbol] which is indicated after [symbol] to express ‘f’ sound in inscribing a word of foreign origin, is inputted.

Also, in order to input Chinese characters in Japanese, hiragana is inputted after the center manipulation region 320 allocated with a Chinese character function is touched, and the Chinese character in Japanese stored in the character storage unit 40 in the communication terminal is read and displayed on the display unit 90.

Here, although a communication terminal typically adopts touch key blocks each being allocated with plural languages in order to use two or more languages in the communication terminal, it is exemplified that the touch key blocks are indicated by a kind of language in the preferred embodiments of the present invention.

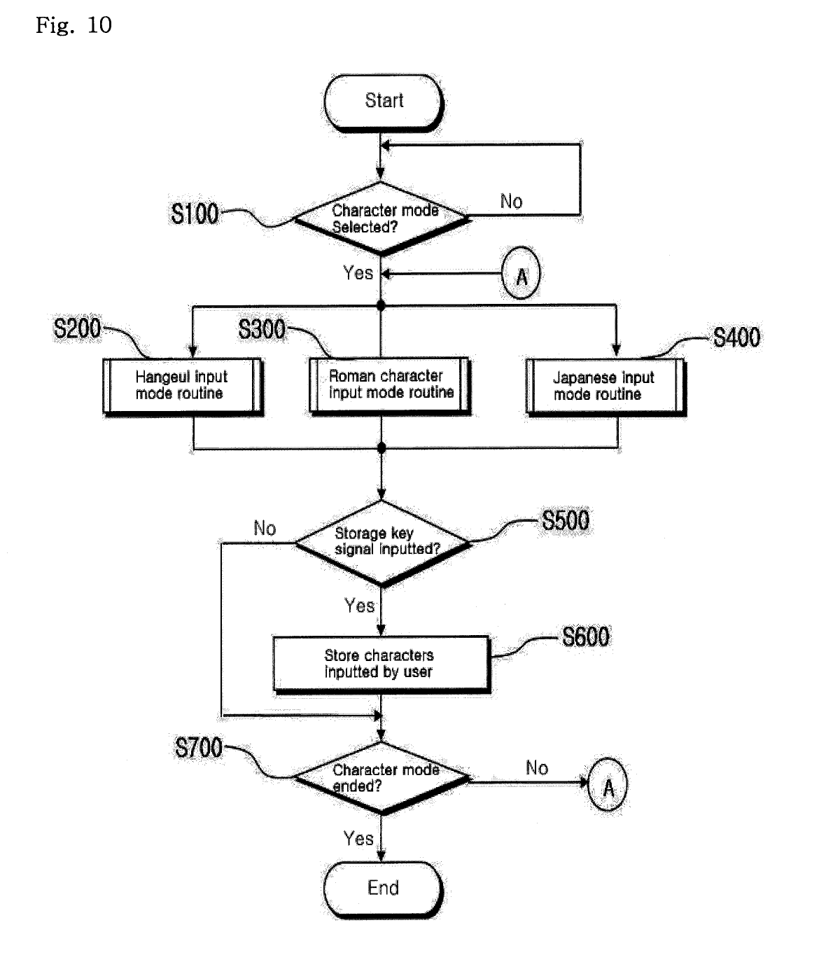

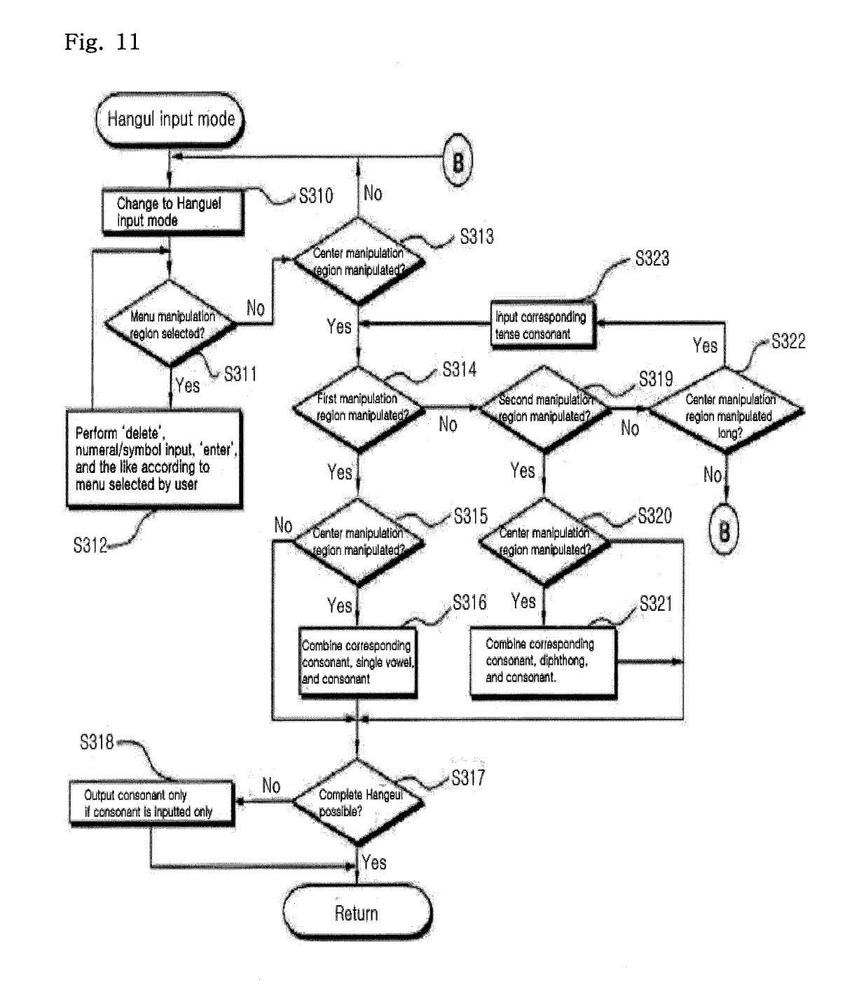

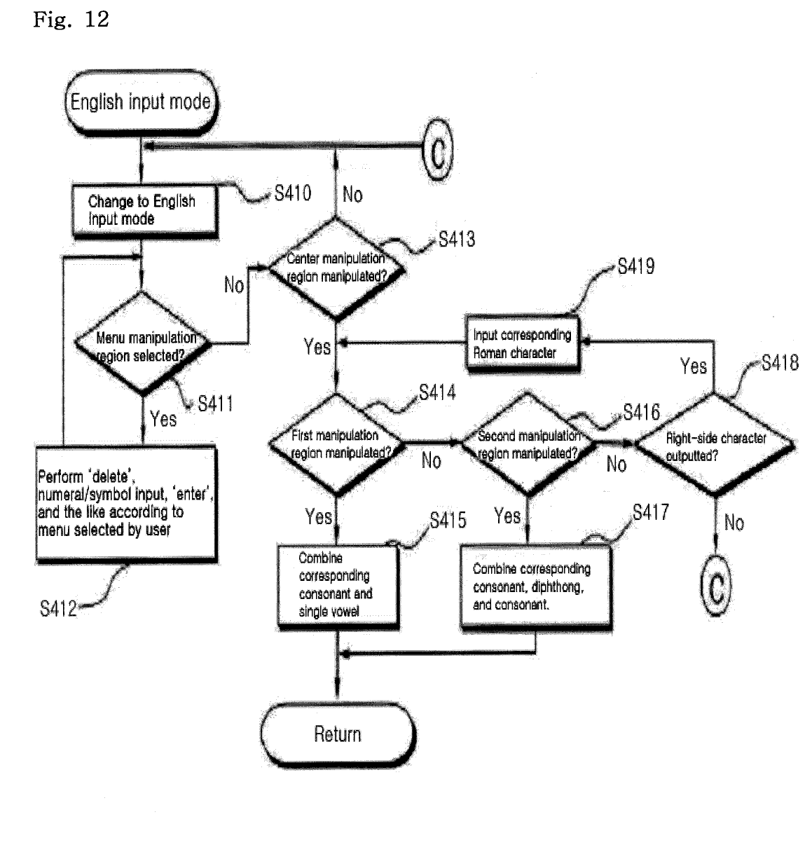

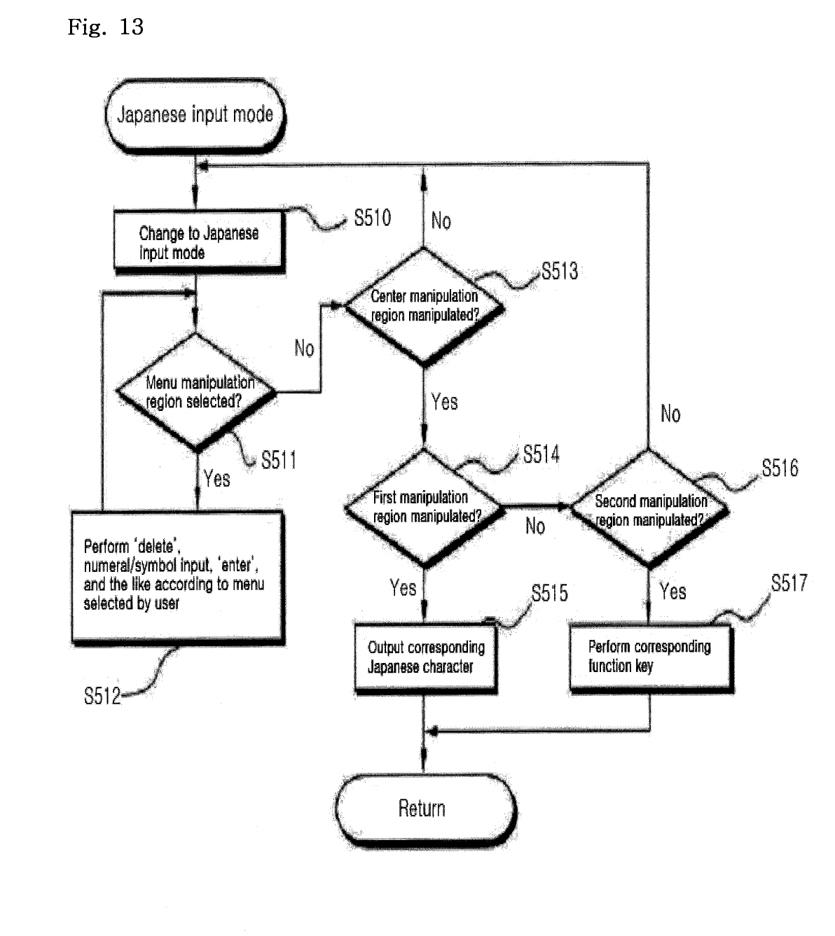

Next, a method for inputting characters/numerals for a communication terminal as constructed above according to an embodiment of the present invention will be described in detail with reference to FIGS. 10 to 13.

FIGS. 10 to 13 are flowcharts illustrating detailed processes of the method for inputting characters/numerals for a communication terminal according to an embodiment of the present invention.

First, the microprocessor of the communication terminal 1 judges where the user selects a character mode for each language (step S100), and if the user has selected the character mode, it judges which mode among a Hangeul input mode, a Roman character input mode, and a Japanese input mode the user selects (step S200).

If the user has selected the Hangeul input mode as a result of judgment in the step S200, the microprocessor of the communication terminal detects a touch signal inputted from a touch key block and a second manipulation region, combines consonants, vowels, and numerals/symbols of the corresponding Hangeul character, and displays the combined Hangeul character on a display screen of the communication terminal (step S200).

Specifically, if the user selects the Hangeul input mode, the microprocessor 70 of the communication terminal changes the present mode to the Hangeul input mode, and maintains a state for waiting for the Hangeul input (step S310). In this state, the microprocessor judges whether the user selects a menu touch key block, and then selects a menu of ‘delete, space bar, numeral/symbol input, or enter’ (step S311).

If the user selects a menu touch key block, the microprocessor of the communication terminal performs the menu of ‘delete, space bar, numeral/symbol input, or enter’, and then repeatedly performs the step S311 and the following steps (step S312).

If the user does not select the menu touch key block as a result of judgment in the step S311, the microprocessor of the communication terminal judges whether the user inputs consonants/vowels by performing the manipulation of the plurality of touch key blocks and the second manipulation region provided in the touch part (step S313).

If the user performs the manipulation of the center manipulation regions of the plurality of touch key blocks and the first manipulation region provided on the touch part, the microprocessor of the communication terminal confirms the input of the Hangeul consonants and the semi-vowels in accordance with the user's manipulation, and if the user performs the manipulation of the center manipulation regions and the second manipulation region of the plurality of touch key blocks, the microprocessor of the communication terminal confirms the input of the Hangeul consonants and the diphthongs in accordance with the user's manipulation (step S314).

Then, if one consonant and one vowel are selected, the microprocessor judges whether a specified center manipulation region to which the consonant is allocated is re-selected by the user (step S315).

If the specified center manipulation region to which the consonant is allocated is re-selected as a result of judgment, the microprocessor judges whether the character according to the user's manipulation is a complete type Hangeul character, and if the complete type Hangeul is possible, the microprocessor performs the above-described step S314 (step S316).

If the character according to the user's manipulation is not the complete type Hangeul character, the microprocessor outputs the corresponding consonants only and performs the step S314 if the character inputted by the user is composed of the consonants only (step S318).

If the allocated specified vowel is not selected in accordance with the user's manipulation of the first and second manipulation regions as a result of judgment in the step S314, the microprocessor judges whether the corresponding center manipulation region is pressed long in accordance with the user's manipulation (step S322).

If the corresponding manipulation region is pressed long in accordance with the user's manipulation, the microprocessor recognizes the corresponding consonant as a tense consonant, and repeatedly performs the step S314 and the following steps.

The microprocessor displays the Hangeul according to the user's input manipulation of the single consonant or diphthong through the steps S314, and repeatedly performs the step S311 and the following steps.

On the other hand, if the user selects the Roman character input mode as a result of judgment in the step S200, the microprocessor of the communication terminal detects a touch signal inputted from the touch key block and the second manipulation region, combines consonants, vowels, and numerals/symbols of the corresponding Roman character, and displays the combined Roman character on the display screen of the communication terminal (step S300).

Specifically, in accordance with the user's selection of the Roman character input mode, the microprocessor of the communication terminal changes the present mode to the Roman character input mode, and then judges whether the user selects a menu touch key block (step S411).

If the user selects the menu touch key block as a result of judgment, the microprocessor of the communication terminal performs the menu of ‘delete, space bar, numeral/symbol input, or enter’ selected by the user, and then repeatedly performs the step S411 and the following steps.

However, if the user does not select the menu touch key block, the microprocessor of the communication terminal judges whether the user inputs consonants/vowels of the Roman characters by performing the manipulation of the plurality of center manipulation regions and the first and second manipulation regions provided on the touch key blocks (step S413).

If the user performs the manipulation of the center manipulation regions and the first manipulation regions provided on the touch key block as a result of judgment, the microprocessor of the communication terminal confirms the input of the Roman consonants/vowels and the semi-vowels in accordance with the user's manipulation, and if the user performs the manipulation of the center manipulation regions and the second manipulation region, the microprocessor of the communication terminal confirms the input of the Roman consonants/vowels and the diphthongs in accordance with the user's manipulation (step S413).

If the specified center manipulation region provided on the touch key block is touched according to the user's manipulation, the microprocessor judges whether the vowels of the first and second manipulation regions are selected in accordance with the user's manipulation of the first and second manipulation regions (step S414).

If one consonant and one vowel are selected as a result of judgment, the microprocessor combines the left-side Roman character allocated to the corresponding center manipulation region and the Roman characters allocated to the first and second manipulation regions, and repeatedly performs the step S412 and the following steps (step S415).

If the specified vowel is not selected in accordance with the user's manipulation as a result of judgment, the microprocessor judges whether the special center manipulation region on the touch key block is pressed long in accordance with the user's manipulation.

If the corresponding center manipulation region is pressed long in accordance with the user's manipulation, the microprocessor recognizes the corresponding character as a capital letter, and repeatedly performs the step S414 and the following steps.

If the corresponding center manipulation region is not pressed long in accordance with the user's manipulation, the microprocessor judges whether the manipulation for outputting the right-side character allocated to the corresponding center manipulation region is performed in accordance with the user's manipulation (step S418).

If the manipulation for outputting the right-side character allocated to the corresponding center manipulation region is performed as a result of judgment, the microprocessor outputs the right-side character allocated to the corresponding center manipulation region, and repeatedly performs the following steps (step S419).

The microprocessor of the communication terminal displays the Roman character on the display unit in accordance with the user's input manipulation of the left-side character or the right-side character through the above-described steps, and repeatedly performs the following steps.

On the other hand, if the user selects the Japanese input mode as a result of judgment in the above-described process, the microprocessor of the communication terminal changes the present mode to the Japanese input mode, and then judges whether the user selects a menu touch key block (step S511).

If the user selects the menu touch key block as a result of judgment, the microprocessor of the communication terminal performs the menu of ‘delete, space bar, numeral/symbol input, or enter’ selected by the user, and then repeatedly performs the step S511 and the following steps (step S512).

However, if the user does not select the menu touch key block, the microprocessor of the communication terminal judges whether the user inputs Japanese composed of hiragana, katakana, and Chinese characters in accordance with the user's manipulation of the center manipulation region or the first and second manipulation regions provided on the touch key block (step S513).

The microprocessor of the communication terminal displays the Japanese composed of hiragana, katakana, and Chinese characters in accordance with the user's manipulation of the center manipulation region or the first and second manipulation regions on the display unit, and repeatedly performs the step S513 and the following steps (step S515).

If the character input work through any one input mode selected among the Hangeul input mode, the Roman character input mode, and the Japanese input mode is finished as a result of judgment, the microprocessor of the communication terminal judges whether the user selects character storage and stores the character inputted by the user (step S600).

The microprocessor of the communication terminal judges whether the user ends the character mode, and continues or removes the character mode.

### INDUSTRIAL APPLICABILITY

As described above, according to the apparatus and method for inputting characters/numerals for a communication terminal according to the present invention, consonants/vowels of characters are arranged on the respective touch key blocks and the second manipulation regions on the touch part provided in the communication terminal so that a user can be well acquainted with such an arrangement. Accordingly, the input of characters and numerals/symbols for each language can be conveniently made with a plurality of active blocks that are generated by touch signals on the respective blocks, and a user can promptly and conveniently input various kinds of characters/numerals of Hangeul, Roman characters, and Japanese with a smaller number of inputs or manipulations than the communication terminal provided with the existing touch screen type keyboard, so that the apparatus and method according to the present invention can contribute to the substantial spread of communication terminals adopting touch screen key input devices. Also, since the apparatus and method according to the present invention makes it possible to input characters/numerals more promptly and conveniently, it is effective in implementing document works, e-mail, chatting, Internet information search, and the like.

While this invention has been described in connection with what is presently considered to be the most practical and preferred embodiments, it is to be understood that the invention is not limited to the disclosed embodiment and the drawings. On the contrary, it is intended to cover various modifications and variations within the spirit and scope of the appended claims.

1. An apparatus for inputting characters/numerals for a communication terminal provided with a touch part, through which designation of coordinates or selection of characters can be performed using a finger or a tool for communications with an outside or data storage, the apparatus comprising:
a touch key block selection means including a plurality of selection blocks in the touch part and providing a corresponding touch key block indicated on a corresponding block as visual images in accordance with a user's touch manipulation;
the touch key block provided as a display by the touch key block selection means and including a center manipulation region defined by a first closed curve and allocated with consonants, vowels, numerals, symbols, and function keys by languages including Hangeul, Roman characters, and Japanese, and a first manipulation region surrounded by a second closed curve, formed with 8 closed sectors composed of upper, lower, left, right, upper left, upper right, lower left, and lower right sectors each having a cut fan shape, and allocated with consonants, vowels, numerals, symbols, and function keys by languages including Hangeul, Roman characters, and Japanese, the first manipulation region being displayed and activated when a touch signal is generated, and being automatically inactivated if a specified time elapses after the touch signal disappears;
a second manipulation region provided on an outer side of the touch key block, which neighbors at least one fan-shaped closed sector, and allocated with consonants, vowels, numerals, symbols, and function keys by languages, the second manipulation region being displayed and activated when the touch signal of the first manipulation region is generated, and being automatically inactivated if a specified time elapses after the touch signal disappears;
a character storage unit storing character data by languages used in the character input apparatus;
a program memory storing an inner operating program of the communication terminal;
a code storage unit storing code data corresponding to the touch signal of the communication terminal;
a touch key block recognition unit detecting a manipulation state of the finger or the tool in the respective touch key blocks provided on the communication terminal;
a second manipulation region recognition unit detecting the manipulation state of the finger or the tool in the second manipulation region provided on the communication terminal;
a microprocessor judging of which language a user inputs a phoneme with reference to the character data stored in the character storage unit in accordance with the operating program stored in the program memory when a finger or tool manipulation state detection signal is inputted through the touch key block recognition unit or the second manipulation region recognition unit, and generating and outputting a display control signal for displaying phonemes of the corresponding language inputted by the user with reference to the code data stored in the code storage unit;
a display drive unit outputting a drive control signal for displaying the visual images of the touch key block selection means or the touch key block and the second manipulation region selected by the user through manipulation of the finger or the tool in the touch region and characters and numerals/symbols generated in accordance with the touch signal of the corresponding manipulation region, in accordance with the display control signal outputted from the microprocessor; and
a display unit displaying the touch key block selection means, the touch key block, the second manipulation region, the characters, and the numerals/symbols on a display screen as the visual images in accordance with the drive control signal outputted from the display drive unit.

2. The apparatus of claim 1, wherein if the touch key block corresponds to a Hangeul mode, consonants are allocated to the corresponding center manipulation regions on the touch key block selection means; [symbol] [symbol] and [symbol] are allocated to the first manipulation region; the number of strokes of the consonants allocated to the second manipulation region is larger than that of the consonants allocated to the first manipulation region; and the vowels on the second manipulation region correspond to the vowels on the first manipulation region in a manner that [symbol] corresponds to [symbol] [symbol] correspond to [symbol] corresponds to [symbol] correspond to [symbol] [symbol] correspond to [symbol] corresponds to [symbol] correspond to [symbol] and [symbol] corresponds to

[symbol]

3. The apparatus of claim 1, wherein if the touch key block corresponds to a Roman character mode, 26 Roman characters of two types are allocated to the corresponding center manipulation regions on the touch key block selection means; 7 vowels of ‘A, E, I, O, U, W, and Y’ are allocated to the first manipulation region; the remaining region is allocated in a lower position, the second Roman character of the corresponding center manipulation regions is inputted during a touch operation; and ‘A, E, I, O, and U’ are allocated to second manipulation region.

4. The apparatus of claim 1, wherein if the touch key block corresponds to a Japanese mode, [symbol] -dan characters of each gyo of Japanese are allocated to the center manipulation regions on the touch key block selection means; and characters of [symbol] dan, [symbol] dan, [symbol] dan, and [symbol] dan are allocated to the first manipulation region.

5. The apparatus of claim 4, [symbol] Chinese character conversion, and hiragana/katakana conversion functions are allocated to the touch key blocks to which [symbol] -dan characters of each gyo of Japanese are not allocated.

6. The apparatus of claim 4, wherein when the character allocated to the respective touch key block is inputted, a pronunciation character [symbol] is inputted by pressing the center manipulation region of the corresponding touch key block once more;
if the center manipulation region of [symbol] allocated to the touch key block is pressed long after the touch key block, to which [symbol] dan is allocated, is touched, a [symbol] is inputted;
if the corresponding region is pressed long after [symbol] allocated to the touch key block is touched, semi-vowels [symbol] are inputted;
if the corresponding region is once touched long in a state that the character of each dan of [symbol] gyo is inputted, [symbol] of each dan of [symbol] gyo is inputted; and
if the corresponding region is once touched long in a state that the character of each dan of [symbol] gyo is inputted, [symbol] which is indicated after [symbol] to express ‘f’ sound in inscribing a word of foreign origin, is inputted.

7. The apparatus of claim 1, wherein consonants, vowels, numerals, symbols, and function keys having the same arrangements as the touch key block for each language are indicated on the touch key block selection means; if the user selects a character input mode, a key image of the corresponding language is displayed on the display screen; and if the user touches a specified key image, the touch key block in the corresponding position is displayed to be activated.

8. The apparatus of claim 1, wherein the touch key block is expanded on the display screen to match the size of a finger around a contact surface at a moment where the touch key block selection means is touched, and simultaneously generates a key input signal of the corresponding position.

9. The apparatus of claim 1, wherein the input of consonants, vowels, numerals, symbols, and function keys by languages of Hangeul, Roman characters, and Japanese is made by making a straight movement to the desired first manipulation region or the second manipulation region in a state that the user's finger or the tool touches the center manipulation region of the corresponding touch key block.

10. The apparatus of claim 1, wherein the second manipulation regions are surrounded by closed curves in the touch part, and the remaining regions except for the second manipulation regions are activated if touch signals of the second manipulation regions are generated and are allocated with ‘space bar’ output functions.

11. The apparatus of claim 10, wherein ‘space bar’ output regions are surrounded by closed curves, and the remaining regions except for the ‘space bar’ output regions are activated if touch signals of the ‘space bar’ output regions are generated and are allocated with ‘period’ output functions, and if the ‘period’ output function is selected, the ‘space bar’ output function is inactivated and simultaneously the period is outputted.

12. A method for inputting characters/numerals for a communication terminal, comprising:
(1) a microprocessor of the communication terminal judging whether a user selects a character mode for each language;
(2) the microprocessor of the communication terminal judging which mode among a Hangeul input mode, a Roman character input mode, and a Japanese input mode the user who has selected the character mode selects;
(3) if the Hangeul input mode is selected, the microprocessor of the communication terminal detecting a touch signal inputted from a touch key block and a second manipulation region, combining consonants, vowels, and numerals/symbols of a corresponding Hangeul character, and displaying the combined Hangeul character on a display screen of the communication terminal;
(4) if the Roman character input mode is selected, the microprocessor of the communication terminal detecting a touch signal inputted from the touch key block and the second manipulation region, combining consonants, vowels, and numerals/symbols of a corresponding Roman character, and displaying the corresponding Roman character on the display screen of the communication terminal;
(5) if the Japanese input mode is selected, the microprocessor of the communication terminal detecting a touch signal inputted from the touch key block and the second manipulation region, combining consonants, vowels, and numerals/symbols of a corresponding Japanese character, and displaying the corresponding Japanese character on the display screen of the communication terminal;
(6) if a character input work through any one input mode selected among the Hangeul input mode, the Roman character input mode, and the Japanese input mode is finished, the microprocessor of the communication terminal judging whether the user selects a character storage and storing the character inputted by the user; and
(7) the microprocessor of the communication terminal judging whether the user ends the character mode, and continuing or removing the character mode.

13. The method of claim 12, wherein the step (3) comprises:
(3-1) in accordance with the user's selection of the Hangeul input mode, the microprocessor of the communication terminal changing the present mode to the Hangeul input mode;
(3-2) after the present mode is changed to the Hangeul input mode, the microprocessor of the communication terminal judging whether the user selects a menu touch key block;
(3-3) if the user selects the menu touch key block, the microprocessor of the communication terminal performing a menu of ‘delete, space bar, numeral/symbol input, or enter’, and then repeatedly performing the step (3-2) and the following steps;
(3-4) if the user does not select the menu touch key block, the microprocessor of the communication terminal judging whether the user inputs consonants/vowels by performing the manipulation of the plurality of touch key blocks and the second manipulation region provided in the touch part;
(3-5) if the user performs the manipulation of the center manipulation regions of the plurality of touch key blocks and the first manipulation region provided on the touch part, the microprocessor of the communication terminal confirming the input of the Hangeul consonants and the semi-vowels in accordance with the user's manipulation, and if the user performs the manipulation of the center manipulation regions and the second manipulation region of the plurality of touch key blocks, the microprocessor of the communication terminal confirming the input of the Hangeul consonants and the diphthongs in accordance with the user's manipulation;
(3-6) if one consonant and one vowel are selected, the microprocessor judging whether a specified center manipulation region to which the consonant is allocated is re-selected by the user;
(3-7) if the specified center manipulation region to which the consonant is allocated is re-selected, the microprocessor judging whether the character according to the user's manipulation is a complete type Hangeul character, and if the complete type Hangeul is possible, the microprocessor performing the step (3-5);
(3-8) if the character according to the user's manipulation is not the complete type Hangeul character, the microprocessor outputting the corresponding consonants only and performing the step (3-5) if the character inputted by the user is composed of the consonants only;
(3-9) if the allocated specified vowel is not selected in accordance with the user's manipulation of the first and second manipulation regions as a result of judgment in the step (3-5), the microprocessor judging whether the corresponding center manipulation region is pressed long in accordance with the user's manipulation;
(3-10) if the corresponding manipulation region is pressed long in accordance with the user's manipulation, the microprocessor recognizing the corresponding consonant as a tense consonant, and repeatedly performing the step S314 and the following steps; and
(3-11) the microprocessor displaying the Hangeul according to the user's input manipulation of the single consonant or diphthong through the step (3-5), and repeatedly performing the step (3-2) and the following steps.

14. The method of claim 12, wherein the step (4) comprises:
(4-1) in accordance with the user's selection of the Roman character input mode, the microprocessor of the communication terminal changing the present mode to the Roman character input mode;
(4-2) after the present mode is changed to the Roman character input mode, the microprocessor of the communication terminal judging whether the user selects a menu touch key block;
(4-3) if the user selects the menu touch key block, the microprocessor of the communication terminal performing the menu of ‘delete, space bar, numeral/symbol input, or enter’ selected by the user, and then repeatedly performing the step (4-2) and the following steps;
(4-4) if the user does not select the menu touch key block, the microprocessor of the communication terminal judging whether the user inputs consonants/vowels of the Roman characters by performing the manipulation of the plurality of center manipulation regions and the first and second manipulation regions provided on the touch key blocks;
(4-5) if the user performs the manipulation of the center manipulation regions and the first manipulation regions provided on the touch key block as a result of judgment in the step (4-4), the microprocessor of the communication terminal confirming the input of the Roman consonants/vowels and the semi-vowels in accordance with the user's manipulation, and if the user performs the manipulation of the center manipulation regions and the second manipulation region, the microprocessor of the communication terminal confirming the input of the Roman consonants/vowels and the diphthongs in accordance with the user's manipulation;
(4-6) if the specified center manipulation region provided on the touch key block is touched according to the user's manipulation, the microprocessor judging whether the vowels of the first and second manipulation regions are selected in accordance with the user's manipulation of the first and second manipulation regions;
(4-7) if one consonant and one vowel are selected, the microprocessor combining the left-side Roman character allocated to the corresponding center manipulation region and the Roman characters allocated to the first and second manipulation regions, and repeatedly performing the step (4-2) and the following steps;
(4-8) if the specified vowel is not selected in accordance with the user's manipulation as a result of judgment in the step (4-6), the microprocessor judging whether the special center manipulation region on the touch key block is pressed long in accordance with the user's manipulation;
(4-9) if the corresponding center manipulation region is pressed long in accordance with the user's manipulation, the microprocessor recognizing the corresponding character as a capital letter, and repeatedly performing the step (4-6) and the following steps;
(4-10) if the corresponding center manipulation region is not pressed long in accordance with the user's manipulation as a result of judgment in the step (4-9), the microprocessor judging whether the manipulation for outputting the right-side character allocated to the corresponding center manipulation region is performed in accordance with the user's manipulation;
(4-11) if the manipulation for outputting the right-side character allocated to the corresponding center manipulation region is performed, the microprocessor outputting the right-side character allocated to the corresponding center manipulation region, and repeatedly performing the step (4-6) and the following steps; and
(4-12) the microprocessor of the communication terminal displaying the Roman character on the display unit in accordance with the user's input manipulation of the left-side character or the right-side character through the above-described steps, and repeatedly performing the step (4-2) and the following steps.

15. The method of claim 12, wherein the step (5) comprises:
(5-1) in accordance with the user's selection of the Japanese input mode, the microprocessor of the communication terminal changing the present mode to the Japanese input mode;
(5-2) after the present mode is changed to the Japanese input mode, the microprocessor of the communication terminal judging whether the user selects a menu touch key block;
(5-3) if the user selects the menu touch key block, the microprocessor of the communication terminal performing the menu of ‘delete, space bar, numeral/symbol input, or enter’ selected by the user, and then repeatedly performing the step (5-2) and the following steps;
(5-4) if the user does not select the menu touch key block, the microprocessor of the communication terminal judging whether the user inputs Japanese composed of hiragana, katakana, and Chinese characters in accordance with the user's manipulation of the center manipulation region or the first and second manipulation regions provided on the touch key block; and
(5-5) the microprocessor of the communication terminal displaying the Japanese composed of hiragana, katakana, and Chinese characters in accordance with the user's manipulation of the center manipulation region or the first and second manipulation regions on the display unit, and repeatedly performing the step (5-2) and the following steps.
